(19) United States
(12) Patent Application Publication
(10) Pub. No.: US 2026/0006153 A1
(43) Pub. Date: Jan. 1, 2026

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventor: Toshihiro OOGUNI, Saitama-shi (JP)

(73) Assignee: FUJIFILM Corporation, Tokyo (JP)

(21) Appl. No.: 19/316,904

(22) Filed: Sep. 2, 2025

Related U.S. Application Data
(63) Continuation of application No. PCT/JP2024/005004, filed on Feb. 14, 2024.

(30) Foreign Application Priority Data
Mar. 3, 2023 (JP) 2023-032762

(51) Int. Cl. H04N 5/74

(52) U.S. Cl. CPC H04N 5/74

(57) ABSTRACT

An information processing apparatus includes a processor. The processor is configured to: acquire first image data representing a first image in which a space is displayed; determine a position of a virtual projection surface and a position of a virtual projection apparatus in the space; determine a first region indicating a part of a region in the virtual projection surface; determine a first projection region indicating a range of projection light from the virtual projection apparatus to the first region based on the position of the virtual projection surface, the position of the virtual projection apparatus, and the first region; and output second image data representing a second image in which the first projection region is displayed on the first image to an output destination.

### CROSS-REFERENCE TO RELATED APPLICATIONS

This is a continuation of International Application No. PCT/JP2024/005004 filed on Feb. 14, 2024, and claims priority from Japanese Patent Application No. 2023-032762 filed on Mar. 3, 2023, the entire content of which is incorporated herein by reference.

### BACKGROUND OF THE INVENTION

### 1. Field of the Invention

The present invention relates to an information processing apparatus, an information processing method, and a computer-readable medium.

### 2. Description of the Related Art

JP2022-123300A discloses an information processing apparatus comprising a camera on a rear surface and a touch panel on a front surface, and displaying a composite image obtained by superimposing a path image indicating a path of light used in a case where projecting the sample image from a projector image, a sample image, and the projector on an image of a target space imaged by the camera in a real space on touch panel.

JP2022-119093A discloses an information processing apparatus comprising an imaging apparatus, a touch panel, and a storage device in which a program is stored, and in a case where the program is executed, imaging a space including a projection surface and in which a projector is disposed by the imaging apparatus, and displaying a simulation image for allowing a user to designate a positional relationship between the projector and the projection surface and a size of a projection image projected from the projector to the projection surface on the touch panel.

WO2019/012774A discloses a projection system including an information processing apparatus, a projection control device, a projector, and a screen, in which the information processing apparatus includes a reception unit that receives a projection condition from a user, a disposition control unit that automatically designs a disposition of the projector based on the projection condition received by the reception unit and outputs the projection condition as projector disposition information, and an evaluation unit that evaluates the projector disposition information based on projection state information indicating a simulation result regarding intersection between a ray projected from the projector and an object other than the screen.

### SUMMARY OF THE INVENTION

One embodiment according to the technology of the present disclosure provides an information processing apparatus, an information processing method, and a computer-readable medium capable of improving convenience of installation of a projection apparatus.

(1)

An information processing apparatus comprising: a processor, in which the processor is configured to: acquire first image data representing a first image in which a space is displayed; determine a position of a virtual projection surface and a position of a virtual projection apparatus in the space; determine a first region indicating a part of a region in the virtual projection surface; determine a first projection region indicating a range of projection light from the virtual projection apparatus to the first region based on the position of the virtual projection surface, the position of the virtual projection apparatus, and the first region; and output second image data representing a second image in which the first projection region is displayed on the first image to an output destination.

(2)

The information processing apparatus according to (1), in which the second image is an image in which the virtual projection surface and the virtual projection apparatus are displayed on the first image.

(3)

The information processing apparatus according to (1) or (2), in which the processor is configured to: determine a second region indicating a part of the virtual projection surface and is different from the first region; and determine a second projection region indicating a range of projection light from the virtual projection apparatus to the second region based on a position of the virtual projection surface, a position of the virtual projection apparatus, and the second region, and the second image is an image in which the second projection region on the first image is displayed.

(4)

The information processing apparatus according to any one of (1) to (3), in which the processor is configured to determine the first projection region based on an energy density of the projection light from the virtual projection apparatus to the first region.

(5)

The information processing apparatus according to any one of (1) to (4), in which the processor is configured to determine a first spatial region in the space, and the second image is an image representing an overlap relationship between the first projection region and the first spatial region.

(6)

The information processing apparatus according to any one of (1) to (5), in which the processor is configured to determine a first spatial region in the space, and the second image is an image representing a region corresponding to an overlapping portion between the first projection region and the first spatial region in the first region.

(7)

The information processing apparatus according to any one of (1) to (6), in which the processor is configured to: determine a position of a second virtual projection apparatus different from the virtual projection apparatus in the space; and determine a third projection region indicating the range of the projection light from the second virtual projection apparatus to the first region based on the position of the virtual projection surface, the position of the second virtual projection apparatus, and the first region, and the second image is an image in which the third projection region is displayed on the first image.

(8)

The information processing apparatus according to any one of (1) to (7), in which the processor is configured to output a determination result of a positional relationship between a specific object detected from the space and a specific region in the space.

(9)

The information processing apparatus according to (8), in which the specific object is an information terminal, and the processor is configured to output a determination result of a positional relationship between a region obtained by extending a region of the information terminal in a height direction and the specific region.

(10)

The information processing apparatus according to (8) or (9), in which the specific object is an information terminal, and the processor is configured to perform, based on the determination result, control of increasing luminance of a light emitting part of the information terminal.

(11)

The information processing apparatus according to any one of (1) to (10), in which the processor is configured to: determine an effective region of a device installed in the space; and determine an overlapping region between the effective region and a specific region in the space, and the second image is an image in which the overlapping region is displayed on the first image.

(12)
The information processing apparatus according to any one of (1) to (11), further comprising: an imaging apparatus and a display device, wherein the first image data is imaging data obtained by imaging the space with the imaging apparatus, and the output destination is the display device.
(13)

An information processing method executed by a processor included in an information processing apparatus, the information processing method comprising: acquiring first image data representing a first image in which a space is displayed; determining a position of a virtual projection surface and a position of a virtual projection apparatus in the space; determining a first region indicating a part of a region in the virtual projection surface; determining a first projection region indicating a range of projection light from the virtual projection apparatus to the first region based on the position of the virtual projection surface, the position of the virtual projection apparatus, and the first region; and outputting second image data representing a second image in which the first projection region is displayed on the first image to an output destination.

(14)

A non-transitory computer-readable medium storing an information processing program for causing a processor included in an information processing apparatus to execute a process, the process comprising: acquiring first image data representing a first image in which a space is displayed; determining a position of a virtual projection surface and a position of a virtual projection apparatus in the space; determining a first region indicating a part of a region in the virtual projection surface; determining a first projection region indicating a range of projection light from the virtual projection apparatus to the first region based on the position of the virtual projection surface, the position of the virtual projection apparatus, and the first region; and outputting second image data representing a second image in which the first projection region is displayed on the first image to an output destination.

According to the present invention, it is possible to provide an information processing apparatus, an information processing method, and a computer-readable medium capable of improving convenience of a installation of a projection apparatus.

### BRIEF DESCRIPTION OF THE DRAWINGS

FIG. 1 is a schematic diagram showing an example of a projection apparatus 10 that is a target for installation support by an information processing apparatus according to an embodiment.

FIG. 2 is a schematic diagram showing an example of an internal configuration of a projection portion 1 shown in FIG. 1.

FIG. 3 is a schematic diagram showing an external configuration of the projection apparatus 10.

FIG. 4 is a schematic cross-sectional diagram of an optical unit 106 of the projection apparatus 10 shown in FIG. 3.

FIG. 5 is a diagram showing an example of an information processing apparatus 50 according to the embodiment.

FIG. 6 is a diagram showing an example of a hardware configuration of the information processing apparatus 50.

FIG. 7 is a diagram in which a virtual projection surface 72, a virtual projection apparatus 73, and an ROI 1 are set in a space in the first aspect.

FIG. 8 is a diagram in which a first projection region 74 is set in the space shown in FIG. 7.

FIG. 9 is diagrams in which an ROI 1 and an ROI 2 are designated as a part of a region in the virtual projection surface 72.

FIG. 10 is a diagram in which a first projection region 74 for an ROI 1 and a second projection region 75 for an ROI 2 are set.

FIG. 11 is a diagram showing an example of a projection region based on energy density.

FIG. 12 is a diagram in which a virtual projection surface 72, a virtual projection apparatus 73, an ROI 1, and a test target region 77 are set in a space in a second aspect.

FIG. 13 is a diagram showing a logical product region 78 of a first projection region 74 and a test target region 77.

FIG. 14 is a diagram showing a logical difference region 79 between the first projection region 74 and the test target region 77.

FIG. 15 is a diagram in which the virtual projection surface 72, the virtual projection apparatus 73, the ROI 1, and the logical product region 78 are set in the space.

FIG. 16 is a diagram showing a logical product region in a case where an ROI 1 and an ROI 2 are designated in a virtual projection surface 72.

FIG. 17 is a diagram showing an example of a virtual projection image 91 in a third aspect.

FIG. 18 is a diagram showing an example of a situation in which a specific object detected in a space enters a specific region of the space in a fourth aspect.

FIG. 19 is a diagram showing an example of a case where determination is performed based on a belonging of a person M.

### DESCRIPTION OF THE PREFERRED EMBODIMENTS

Hereinafter, an example of an embodiment of the present invention will be described with reference to the drawings.

### <Projection Apparatus 10 of Target for Installation Change by Information Processing Apparatus According to Embodiment>

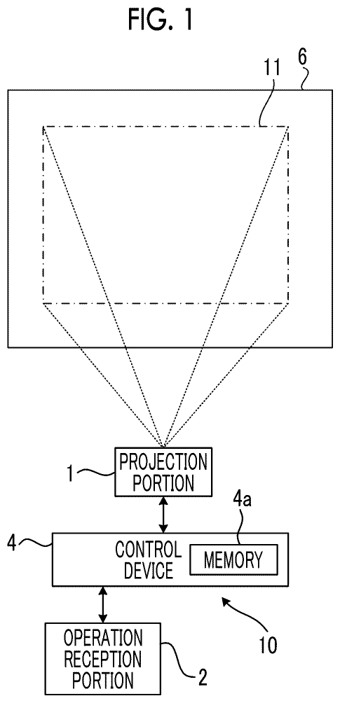

FIG. 1 is a schematic diagram showing an example of a projection apparatus 10 that is a target for installation support by an information processing apparatus according to an embodiment.

The information processing apparatus according to the embodiment can be used, for example, to support installation of the projection apparatus 10. The projection apparatus 10 comprises a projection portion 1, a control device 4, and an operation reception portion 2. The projection portion 1 is composed of, for example, a liquid crystal projector or a projector using liquid crystal on silicon (LCOS). In the following description, it is assumed that the projection portion 1 is a liquid crystal projector.

The control device 4 is a control device that controls projection performed by the projection apparatus 10. The control device 4 is a device including a control unit composed of various processors, a communication interface (not shown) for communicating with each portion, and a memory 4a such as a hard disk, a solid-state drive (SSD), or a read-only memory (ROM) and integrally controls the projection portion 1.

Examples of the various processors of the control unit of the control device 4 include a central processing unit (CPU) which is a general-purpose processor that executes a program to perform various types of processing, a programmable logic device (PLD) which is a processor capable of changing a circuit configuration after manufacture such as a field-programmable gate array (FPGA), a dedicated electrical circuit which is a processor having a circuit configuration exclusively designed to execute specific s processing such as an application-specific integrated circuit (ASIC), or the like.

More specifically, a structure of these various processors is an electrical circuit in which circuit elements such as semiconductor elements are combined. The control unit of the control device 4 may be configured with one of the various processors or may be configured with a combination of two or more processors of the same type or different types (for example, a combination of a plurality of FPGAs or a combination of a CPU and an FPGA).

The operation reception portion 2 detects an instruction from a user by receiving various operations from the user. The operation reception portion 2 may be a button, a key, a joystick, or the like provided in the control device 4 or may be a reception portion or the like that receives a signal from a remote controller for remotely operating the control device 4.

A projection object 6 is an object such as a screen or a wall having a projection surface on which a projection image is displayed by the projection portion 1. In the example shown in FIG. 1, the projection surface of the projection object 6 is a rectangular plane. It is assumed that upper, lower, left, and right sides of the projection object 6 in FIG. 1 are upper, lower, left, and right sides of the actual projection object 6.

A projection range 11 shown by a dot-dashed line is a region irradiated with projection light by the projection portion 1 in the projection object 6. In the example shown in FIG. 1, the projection range 11 is rectangular. The projection range 11 is a part or the entirety of a projectable range within which the projection can be performed by the projection portion 1.

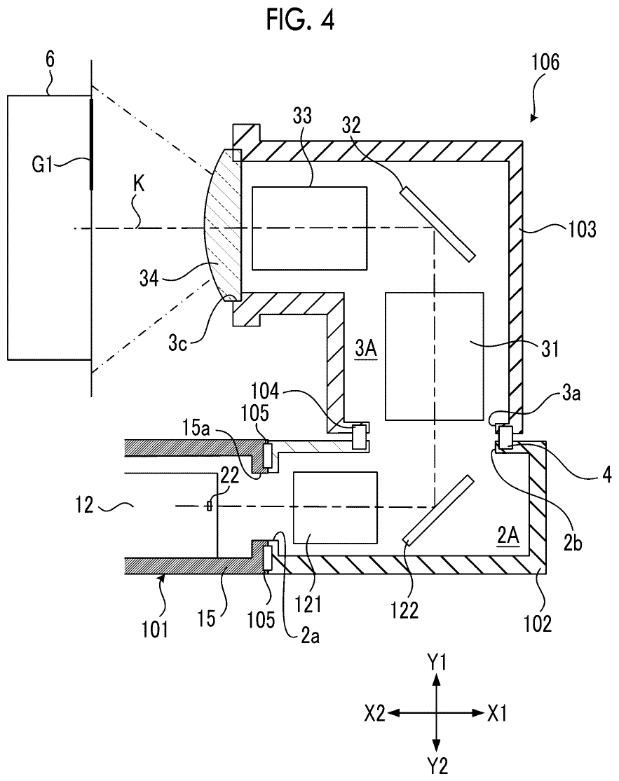

The projection portion 1, the control device 4, and the operation reception portion 2 are implemented by, for example, a single device (for example, see FIGS. 3 and 4). Alternatively, the projection portion 1, the control device 4, and the operation reception portion 2 may be separate devices that cooperate by communicating with each other.

### <Internal Configuration of Projection Portion 1 Shown in FIG. 1>

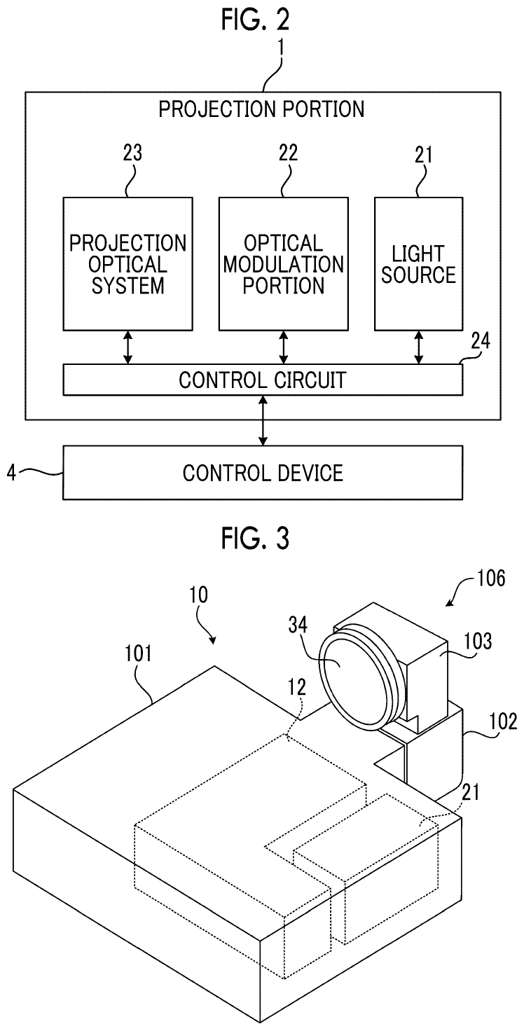

FIG. 2 is a schematic diagram showing an example of an internal configuration of the projection portion 1 shown in FIG. 1.

As shown in FIG. 2, the projection portion 1 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels that emit each color image by modulating, based on image information, each color light beam which is emitted from the light source 21 and is separated into three colors of red, blue, and green by a color separation mechanism (not shown). Filters of red, blue, and green may be mounted in each of the three liquid crystal panels, and each color image may be emitted by modulating the white light emitted from the light source 21 in each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected onto the projection object 6.

In the projection object 6, a region irradiated with the light transmitted through the entire range of the optical modulation portion 22 is the projectable range in which the projection can be performed by the projection portion 1. Within this projectable range, a region irradiated with the light actually transmitted through the optical modulation portion 22 is the projection range 11. For example, in the projectable range, a size, a position, and a shape of the projection range 11 are changed by controlling a size, a position, and a shape of a region through which the light is transmitted in the optical modulation portion 22.

The control circuit 24 controls the light source 21, the optical modulation portion 22, and the projection optical system 23 based on the display data input from the control device 4, thereby projecting an image based on this display data onto the projection object 6. The display data input to the control circuit 24 is composed of three pieces of data including red display data, blue display data, and green display data.

In addition, the control circuit 24 changes the projection optical system 23 based on an instruction input from the control device 4, thereby enlarging or reducing the projection range 11 (see FIG. 1) of the projection portion 1. In addition, the control device 4 may move the projection range 11 of the projection portion 1 by changing the projection optical system 23 based on the operation received by the operation reception portion 2 from the user.

The projection apparatus 10 also comprises a shift mechanism that mechanically or optically moves the projection range 11 while maintaining an image circle of the projection optical system 23. The image circle of the projection optical system 23 is a region where the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting or an electronic shift mechanism that performs electronic shifting.

The optical system shift mechanism is, for example, a mechanism (for example, see FIGS. 3 and 4) that moves the projection optical system 23 in a direction perpendicular to an optical axis or a mechanism that moves the optical modulation portion 22 in the direction perpendicular to the optical axis instead of moving the projection optical system 23. Furthermore, the optical system shift mechanism may perform the movement of the projection optical system 23 and the movement of the optical modulation portion 22 in combination with each other.

The electronic shift mechanism is a mechanism that performs pseudo shifting of the projection range 11 by changing a range through which the light is transmitted in the optical modulation portion 22.

The projection apparatus 10 may also comprise a projection direction changing mechanism that moves the image circle of the projection optical system 23 and the projection range 11. The projection direction changing mechanism is a mechanism that changes a projection direction of the projection portion 1 by changing the orientation of the projection portion 1 through mechanical rotation (for example, see FIGS. 3 and 4).

### <Mechanical Configuration of Projection Apparatus 10>

FIG. 3 is a schematic diagram showing an external configuration of the projection apparatus 10. FIG. 4 is a schematic cross-sectional diagram of an optical unit 106 of the projection apparatus 10 shown in FIG. 3. FIG. 4 shows a cross section in a plane along an optical path of light emitted from a body part 101 shown in FIG. 3.

As shown in FIG. 3, the projection apparatus 10 comprises the body part 101 and the optical unit 106 that is provided to protrude from the body part 101. In the configuration shown in FIG. 3, the operation reception portion 2, the control device 4, and the light source 21, the optical modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (see FIG. 4) in which an opening 15a (see FIG. 4) for passing light is formed in a part connected to the optical unit 106.

As shown in FIG. 3, the light source 21 and an optical modulation unit 12 including the optical modulation portion 22 (see FIG. 2) that generates an image by spatially modulating the light emitted from the light source 21 based on input image data are provided inside the housing 15 of the body part 101.

The light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 is incident on the optical unit 106 by passing through the opening 15a of the housing 15 and is projected onto the projection object 6 as a projection target object. Accordingly, an image G1 is visible from an observer.

The optical unit 106, as shown in FIG. 4, comprises the first member 102 including a hollow portion 2A connected to the inside of the body part 101, the second member 103 including a hollow portion 3A connected to the hollow portion 2A, a first optical system 121 and a reflective member 122 disposed in the hollow portion 2A, a second optical system 31, a reflective member 32, a third optical system 33, and a lens 34 disposed in the hollow portion 3A, a shift mechanism 105, and a projection direction changing mechanism 104.

The first member 102 is a member having, for example, a rectangular cross-sectional outer shape, in which an opening 2a and an opening 2b are formed in surfaces perpendicular to each other. The first member 102 is supported by the body part 101 in a state in which the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

The incidence direction of the light incident into the hollow portion 2A from the body part 101 will be referred to as a direction X1, the direction opposite to the direction X1 will be referred to as a direction X2, and the direction X1 and the direction X2 will be collectively referred to as a direction X. In FIG. 4, the direction from the front to the back of the page and the opposite direction thereto will be referred to as a direction Z. In the direction Z, the direction from the front to the back of the page will be referred to as a direction Z1, and the direction from the back to the front of the page will be referred to as a direction Z2.

In addition, the direction perpendicular to the direction X and to the direction Z will be referred to as a direction Y. In the direction Y, the upward direction in FIG. 4 will be referred to as a direction Y1, and the downward direction in FIG. 4 will be referred to as a direction Y2. In the example in FIG. 4, the projection apparatus 10 is disposed such that the direction Y2 is the vertical direction.

The projection optical system 23 shown in FIG. 2 is composed of the first optical system 121, the reflective member 122, the second optical system 31, the reflective member 32, the third optical system 33, and the lens 34. An optical axis K of the projection optical system 23 is shown in FIG. 4. The first optical system 121, the reflective member 122, the second optical system 31, the reflective member 32, the third optical system 33, and the lens 34 are disposed in this order from the optical modulation portion 22 side along the optical axis K.

The first optical system 121 includes at least one lens and guides the light that is incident on the first member 102 from the body part 101 and travels in the direction X1 to the reflective member 122.

The reflective member 122 reflects the light incident from the first optical system 121 in the direction Y1. The reflective member 122 is composed of, for example, a mirror. In the first member 102, the opening 2b is formed on the optical path of light reflected by the reflective member 122, and the reflected light travels to the hollow portion 3A of the second member 103 by passing through the opening 2b.

The second member 103 is a member having an approximately T-shaped cross-sectional outer shape, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional outer shape and are not limited to the above.

The second optical system 31 includes at least one lens and guides the light incident from the first member 102 to the reflective member 32.

The reflective member 32 reflects the light incident from the second optical system 31 in the direction X2 and guides the light to the third optical system 33. The reflective member 32 is composed of, for example, a mirror.

The third optical system 33 includes at least one lens and guides the light reflected by the reflective member 32 to the lens 34.

The lens 34 is disposed at an end part of the second member 103 on the direction X2 side in a form of closing the opening 3c formed at this end part. The lens 34 projects the light incident from the third optical system 33 onto the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position shown in FIG. 4 as long as the projection direction changing mechanism 104 can rotate the optical system. Furthermore, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be able to change a position of the first member 102 in the direction Y with respect to the body part 101. The shift mechanism 105 may manually move the first member 102 or electrically move the first member 102.

FIG. 4 shows a state in which the first member 102 is moved as far as possible to the direction Y1 side by the shift mechanism 105. By moving the first member 102 in the direction Y2 by the shift mechanism 105 from the state shown in FIG. 4, the relative position between the center of the image (in other words, the center of the display surface) formed by the optical modulation portion 22 and the optical axis K changes, and the image G1 projected onto the projection object 6 can be shifted (translated) in the direction Y2.

The shift mechanism 105 may be a mechanism that moves the optical modulation portion 22 in the direction Y instead of moving the optical unit 106 in the direction Y. Even in this case, the image G1 projected onto the projection object 6 can be moved in the direction Y2.

### <Information Processing Apparatus 50 According to Embodiment>

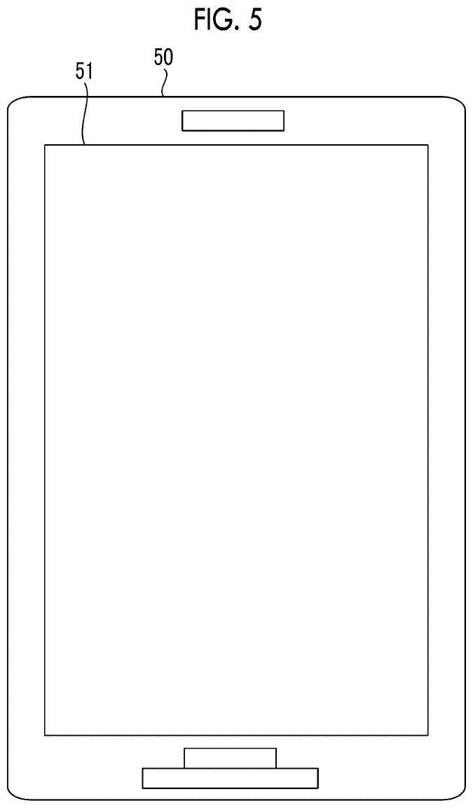

FIG. 5 is a diagram showing an example of the information processing apparatus 50 according to the embodiment. The information processing apparatus 50 according to the embodiment is a tablet terminal and the like having a touch panel 51. The touch panel 51 is a display that allows a touch operation. For example, in a case where projection is performed using the projection apparatus 10 in a space such as a room, the information processing apparatus 50 is used to find an appropriate installation position of the projection apparatus 10 and the projection object 6 to which light is projected from the projection apparatus 10. A user of the information processing apparatus 50 brings the information processing apparatus 50 into a space (room) in which the projection is performed by the projection apparatus 10. The information processing apparatus 50 displays an installation support image for supporting installation of the projection apparatus 10 and the projection object 6 in the space on the touch panel 51.

For example, the information processing apparatus 50 displays, as an installation support image, a second image in which an image of a virtual projection surface, which is a virtually-defined projection surface, and an image of a virtual projection apparatus, which is a virtually-defined projection apparatus, are superimposed on a first image obtained by imaging the space in which the projection apparatus 10 is installed and performs the projection. The user of the information processing apparatus 50 can acquire information related to the installation of the projection apparatus 10 and the projection object 6 while referring to the installation support image.

### <Hardware Configuration of Information Processing Apparatus 50>

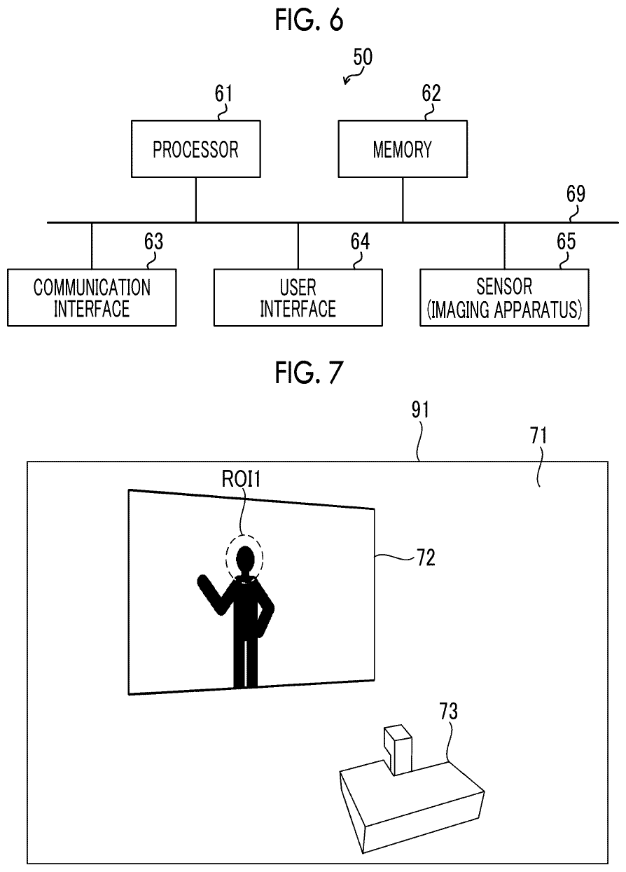

FIG. 6 is a diagram showing an example of a hardware configuration of the information processing apparatus 50. For example, as shown in FIG. 6, the information processing apparatus 50 shown in FIG. 5 comprises a processor 61, a memory 62, a communication interface 63, a user interface 64, and a sensor 65. The processor 61, the memory 62, the communication interface 63, the user interface 64, and the sensor 65 are connected by, for example, a bus 69.

The processor 61 is a circuit that performs signal processing, and is, for example, a CPU that controls the entire information processing apparatus 50. The processor 61 may be implemented by other digital circuits such as an FPGA and a digital signal processor (DSP). The processor 61 may also be implemented by combining a plurality of digital circuits.

For example, the memory 62 includes a main memory and an auxiliary memory. For example, the main memory is a random-access memory (RAM). The main memory is used as a work area of the processor 61.

The auxiliary memory is, for example, a non-volatile memory such as a magnetic disk or a flash memory. The auxiliary memory stores various programs for operating the information processing apparatus 50. The programs stored in the auxiliary memory are loaded into the main memory and executed by the processor 61.

In addition, the auxiliary memory may include a portable memory that can be detached from the information processing apparatus 50. Examples of the portable memory include a memory card such as a universal serial bus (USB) flash drive or a secure digital (SD) memory card, and an external hard disk drive.

The communication interface 63 is a communication interface for communicating with apparatuses outside the information processing apparatus 50. The communication interface 63 includes at least any of a wired communication interface for performing wired communication or a wireless communication interface for performing wireless communication. The communication interface 63 is controlled by the processor 61.

The user interface 64 includes, for example, an input device that receives an operation input from the user, and an output device that outputs information to the user. The input device can be implemented by, for example, a key (for example, a keyboard) or a remote controller. The output device can be implemented by, for example, a display or a speaker. In the information processing apparatus 50 shown in FIG. 5, the input device and the output device are implemented by the touch panel 51. The user interface 64 is controlled by the processor 61. The information processing apparatus 50 receives various types of designation from the user using the user interface 64.

The sensor 65 includes an imaging apparatus that includes an imaging optical system and an imaging element and that can perform imaging, a space recognition sensor that can three-dimensionally recognize a space around the information processing apparatus 50, and the like. For example, the imaging apparatus includes an imaging apparatus provided on a rear surface of the information processing apparatus 50 illustrated in FIG. 5.

The space recognition sensor is, as an example, a light detection and ranging (LiDAR) sensor of performing irradiation with laser light, measuring a time taken until the laser light of irradiation hits an object and reflects back, and measuring a distance and a direction to the object. However, the space recognition sensor is not limited thereto and can be various sensors such as a radar that emits radio waves, and an ultrasonic sensor that emits ultrasound waves.

### <First Aspect of Processing of Information Processing Apparatus 50>

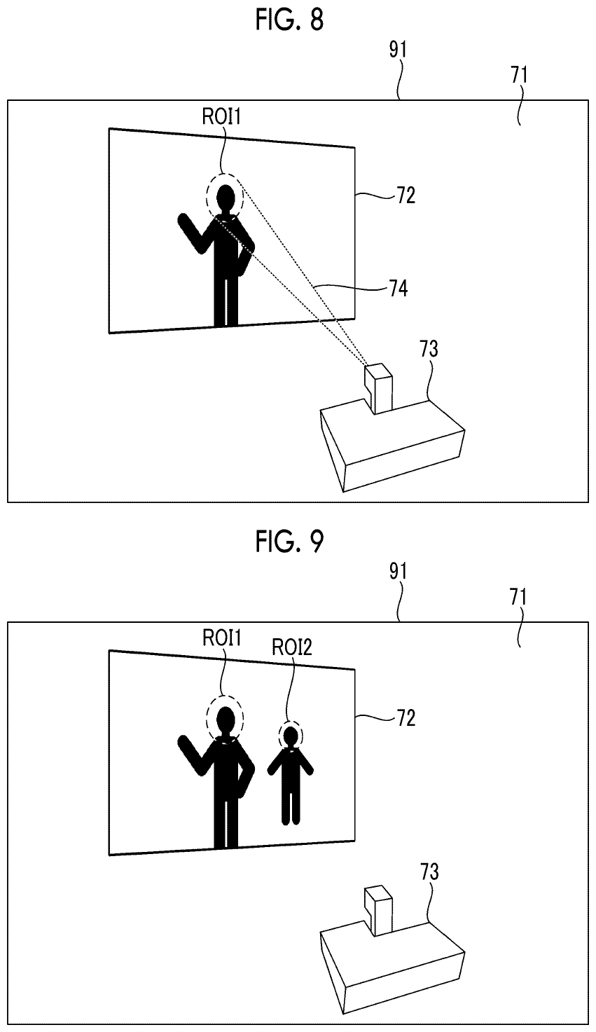

A first aspect of processing of the information processing apparatus 50 will be described with reference to FIGS. 7 and 8. FIG. 7 is a diagram in which a virtual projection surface 72, a virtual projection apparatus 73, and an ROI 1 are set in a space in the first aspect. FIG. 8 is a diagram in which the first projection region 74 is set in the space shown in FIG. 7.

The processor 61 of the information processing apparatus 50 acquires space image data representing the space image 71 of the physical space in which the projection apparatus 10 is installed and the projection is performed by the projection apparatus 10. The “space image 71” may be, for example, a captured image of a space imaged by an imaging apparatus, or may be an image generated from a three-dimensional (3D) model of a space or the like. The imaging apparatus that images the space may be an imaging apparatus that is provided integrally with the information processing apparatus 50 or may be an external imaging apparatus. The space image data is, for example, imaging data of a space obtained by imaging with an imaging apparatus or data of an image generated from a 3D model.

In the following description, the space image 71 will be described as a live view image that shows an image obtained by imaging with the imaging apparatus in real time. The space image 71 is an example of a “first image” in the present invention. The space image data is an example of “first image data” in the present invention.

As shown in FIG. 7, the processor 61 determines a position of the virtual projection surface 72, which is a virtually-defined projection surface, and a position of a virtual projection apparatus 73, which is a virtually-defined projection apparatus, in the space. In addition, the processor 61 determines the ROI 1 indicating a part of a region in the virtual projection surface 72. The ROI 1 is a region designated as a range in which important information is projected among the information content projected onto the virtual projection surface 72. In the present example, the ROI 1 is designated as a circular region surrounded by a broken line. However, the ROI 1 is not limited to a part of the virtual projection surface and may be, for example, an entire region of the virtual projection surface. In addition, a shape of the designated ROI 1 is not limited to a circular shape, and may be, for example, a polygonal shape. The ROI 1 is an example of a “first region” in the present invention.

The position of the virtual projection surface, the position of the virtual projection apparatus, and the ROI 1 may be determined based on an instruction from the user of the information processing apparatus 50, or may be determined based on an analysis processing of the first image. The position of the ROI 1 may be, for example, determined to be a substantially constant position according to the information content projected onto the virtual projection surface 72, or may be moved in the virtual projection surface 72. Specifically, the position of the ROI 1 may be, in a case where the information content is a story, a position of a face of a main character, and in a case where there is a subtitle display, a position of a subtitle.

As shown in FIG. 8, the processor 61 determines the first projection region 74 based on the position of the virtual projection surface 72, the position of the virtual projection apparatus 73, and the ROI 1. The first projection region 74 is a region indicating a range of projection light projected from the virtual projection apparatus 73 to the ROI 1. The first projection region 74 is displayed as a projection region continuous from the virtual projection apparatus 73 to the ROI 1. The first projection region 74 is a conical projection region extending from the virtual projection apparatus 73 to the ROI 1. However, in a case where the shape of the ROI 1 is a polygonal shape, the shape of the first projection region 74 is a pyramid-shaped projection region.

The processor 61 generates the virtual projection image 91 based on the virtual projection surface 72, the virtual projection apparatus 73, and the first projection region 74. The virtual projection image 91 is an image in which the virtual projection surface 72, the virtual projection apparatus 73, and the first projection region 74 are displayed on the space image 71. The virtual projection image 91 may be, for example, generated as an image in which the first projection region 74 is displayed on the space image 71. The virtual projection image 91 is an example of a “second image” in the present invention.

The processor 61 acquires virtual projection image data representing the virtual projection image 91. The processor 61 outputs the acquired virtual projection image data to a predetermined output destination. The output destination of the virtual projection image data may be, for example, a display unit (touch panel 51) provided by being integrated with the information processing apparatus 50, or may be an external display device provided outside the information processing apparatus 50. The virtual projection image data is an example of “second image data” in the present invention.

As described above, the information processing apparatus 50 of the first aspect outputs to the touch panel 51 the virtual projection image 91, in which the virtual projection apparatus 73, the virtual projection surface 72, the ROI 1 in the virtual projection surface 72, and the first projection region 74 indicating the range of the projection light from the virtual projection apparatus 73 to the ROI 1 are displayed on the space image 71. According to this configuration, the user who wants to project the information content by the projection apparatus 10 can designate the ROI 1 as a region in which the important information content is displayed, and thus the first projection region 74 representing the range of the projection light for projecting the ROI 1 can be displayed. As a result, for example, the user can easily recognize a region on a space in which a shadow is generated in the ROI 1 by the audience or the like entering between the virtual projection apparatus 73 and the virtual projection surface 72. Therefore, it is easy to design the installation position of the projection apparatus 10 in a case where the projection apparatus 10 and the projection object 6 are installed, the position of the installation object installed around the projection apparatus 10, the movement line of the audience, and the like, and to correct the information content to be projected, and it is possible to improve convenience.

### First Modification Example in First Aspect

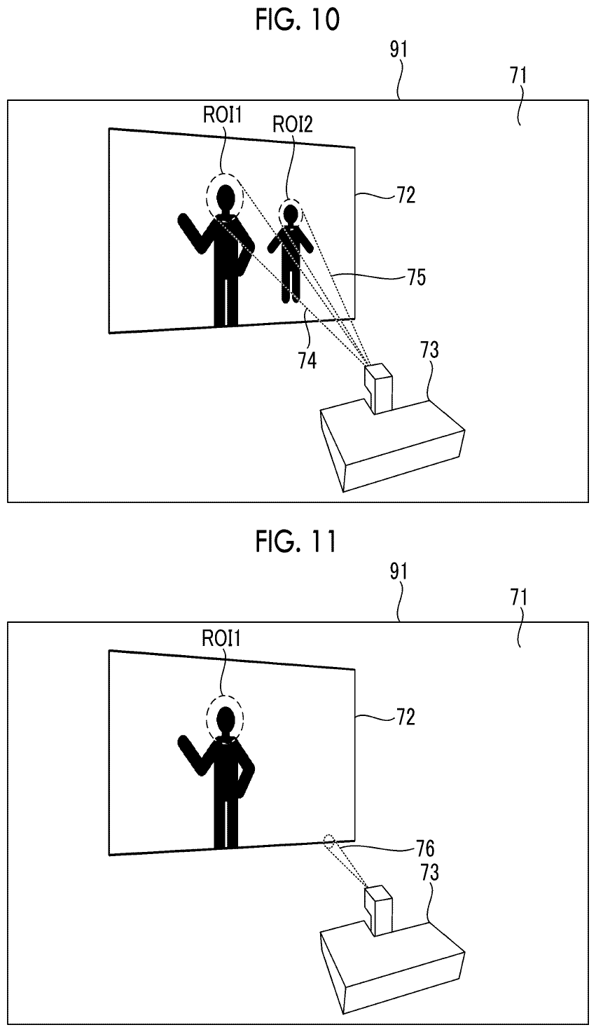

A first modification example of the processing of the information processing apparatus 50 in the first aspect will be described with reference to FIGS. 9A and 9B and 10. FIGS. 9A and 9B are diagram in which ROI 1 and ROI 2 are designated as a part of a region in the virtual projection surface 72. FIG. 10 is a diagram in which a first projection region 74 for the ROI 1 and a second projection region 75 for the ROI 2 are set. In the first aspect, a case where one ROI 1 is designated as an example of designating a partial region in the virtual projection surface 72 has been described, but the number of regions to be designated may be plural as shown in the first modification example.

As shown in FIGS. 9A and 9B, the processor 61 determines an ROI 2 indicating a partial region in the virtual projection surface 72. The ROI 2 is a partial region in the virtual projection surface different from the ROI 1. In the present example, the ROI 2 is designated as a circular region surrounded by a broken line at a position of a face of a main character different from the protagonist of the ROI 1 designated among the two main characters included in the information content. The ROI 2 is an example of a “second region” in the present invention.

As shown in FIG. 10, the processor 61 determines the second projection region 75 based on the position of the virtual projection surface 72, the position of the virtual projection apparatus 73, and the ROI 2. The second projection region 75 is a region indicating a range of projection light projected from the virtual projection apparatus 73 to the ROI 2.

The processor 61 generates the virtual projection image 91 based on the virtual projection surface 72, the virtual projection apparatus 73, the second projection region 75, and the first projection region 74. The virtual projection image 91 is an image in which the virtual projection surface 72, the virtual projection apparatus 73, the second projection region 75, and the first projection region 74 are displayed on the space image 71. The virtual projection image 91 may be, for example, generated as an image in which the second projection region 75 and the first projection region 74 are displayed on the space image 71.

The processor 61 acquires the virtual projection image data representing the virtual projection image 91 and outputs the acquired virtual projection image data to the output destination (for example, the touch panel 51) in the same manner as in the first aspect.

Even in a case where there are a plurality of pieces of important information (ROI 1 and ROI 2) in the information content projected onto the virtual projection surface 72 as in the first modification example, the same effect as the first aspect can be obtained.

### Second Modification Example in First Aspect

A second modification example of the processing of the information processing apparatus 50 in the first aspect will be described with reference to FIG. 11. FIG. 11 is a diagram showing an example of a projection region based on the energy density.

In the first aspect, the first projection region 74 that is continuously displayed from the virtual projection apparatus 73 to the ROI 1 has been described, but the shape of the first projection region 74 may be a shape determined based on a predetermined condition. For example, the shape of the first projection region 74 may be a shape determined based on the energy density of the projection light calculated from the specifications of the projection apparatus 10. The specifications of the projection apparatus 10 include, for example, a projection light amount and an angle of view of a lens.

In a case where the audience of the projection image is irradiated with projection light projected from the projection apparatus 10, the audience may feel the irradiated projection light as uncomfortable glare or uncomfortable heat. Whether the projection light is perceived as uncomfortable glare or uncomfortable heat varies depending on the energy density of the projection light. Therefore, for example, the minimum light energy amount that is perceived as uncomfortable in a case of entering the human eye is detected, and the value of the energy density per unit area obtained from the minimum light energy amount is calculated as the threshold value. Specifically, a cross-sectional area of a first projection region 74 (see FIG. 8) that extends in a conical shape and is cut by a plane perpendicular to a line segment connecting the center of the lens of the virtual projection apparatus 73 and the center of the ROI 1, and the luminous flux of the projection light from the virtual projection apparatus 73 that passes through the cross section are used to calculate the energy density of the projection light, and a portion in which the value is equal to or greater than the threshold value is set as the first projection region 76.

As shown in FIG. 11, the processor 61 determines the first projection region 76 based on the energy density of the projection light from the virtual projection apparatus 73 to the ROI 1. The first projection region 76 in the present example is displayed as a conical first projection region 76 obtained by cutting a conical projection region extending from the virtual projection apparatus 73 to the ROI 1 in the middle.

In a case of performing a presentation using the projection apparatus 10 or a case of performing a space performance by projecting onto all surfaces of a room, a presenter or an audience may face a direction of a lens of the projection apparatus 10, and thus may feel uncomfortable glare. In order to suppress such a thing, as in the second modification example, the first projection region 76 can be displayed based on the energy density of the projection light and the threshold value. By grasping a region where uncomfortable glare is felt based on the energy density of the projection light, and performing projection by moving the virtual projection apparatus 73 away from the virtual projection surface 72 or performing lens shift, it is possible to set an appropriate position of the virtual projection apparatus 73 and a position of the virtual projection surface 72 where uncomfortable glare is less likely to occur.

### Third Modification Example in First Aspect

In the second modification example, a case where the shape (length) of the first projection region 76 is set based on the threshold value of the energy density in the projection light from the virtual projection apparatus 73 to the ROI 1 has been described. However, for example, the first projection region 74 (see FIG. 8) may be displayed in color according to the energy density of the projection light.

Specifically, in the conical first projection region 74 extending from the virtual projection apparatus 73 to the ROI 1 shown in FIG. 8, a projection region having a high energy density may be displayed in a dark color, and a projection region having a low energy density may be displayed in a light color. For example, the projection region on a virtual projection apparatus 73 side having a high energy density may be displayed in a dark color, and the projection region may be gradually displayed in a light color as the projection region approaches the ROI 1.

In a narrow space where the installation position of the projection apparatus 10 is limited, it may be difficult to prevent the audience from feeling discomfort due to glare. Therefore, the degree of discomfort felt by the audience is measured based on the level of the energy density of the projection light, and the first projection region 74 is displayed in color according to the degree of discomfort. As a result, it is possible to display a region that is a region where the audience feels extremely uncomfortable glare and that needs to be designed in a manner that the audience does not enter, a region that is a region where the audience feels a certain degree of discomfort and that needs to be designed in a manner that the audience does not enter, and the like in a divided manner. Therefore, it is easy to design a movement line that can suppress the discomfort of the audience due to the projection light.

### <Second Aspect of Processing of Information Processing Apparatus 50>

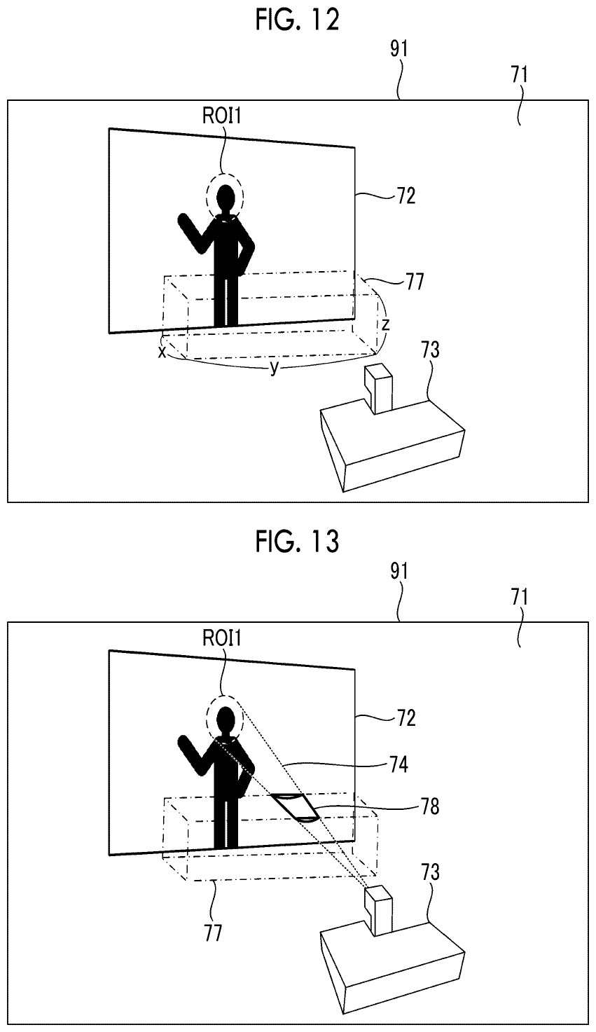

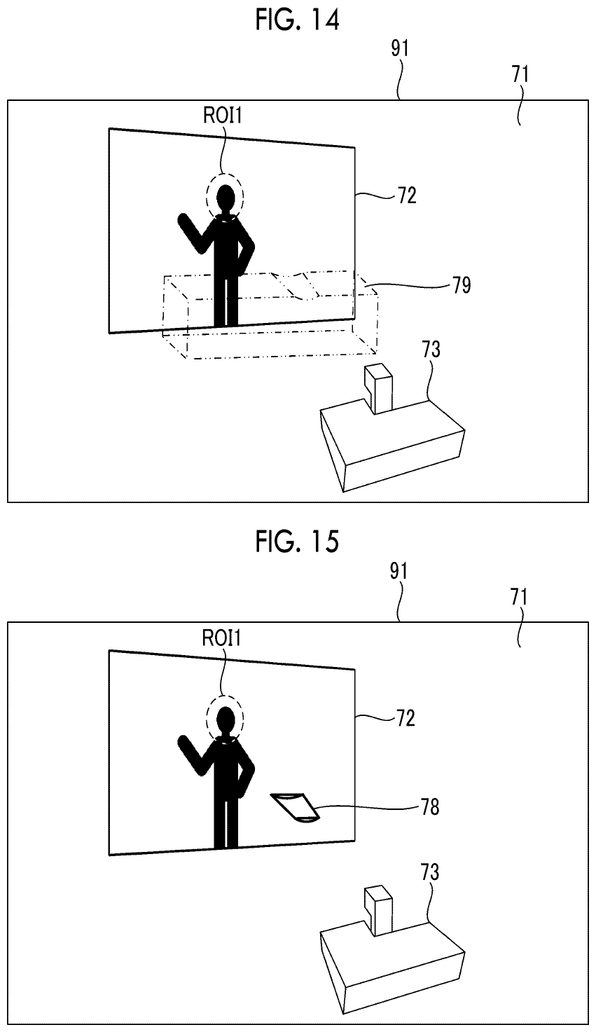

A second Aspect of the processing of the information processing apparatus 50 will be described with reference to FIGS. 12 to 14. FIG. 12 is a diagram in which a virtual projection surface 72, a virtual projection apparatus 73, an ROI 1, and a test target region 77 are set in a space in the second aspect. FIG. 13 is a diagram showing a logical product region 78 of the first projection region 74 and the test target region 77. FIG. 14 is a diagram showing a logical difference region 79 between the first projection region 74 and the test target region 77.

As shown in FIG. 12, the processor 61 determines the position of the virtual projection surface 72, the position of the virtual projection apparatus 73, the ROI 1, and the test target region 77 in the space in which the projection is performed by the projection apparatus 10. The test target region 77 is a region assumed as a movement line of an audience who views the projection image. The test target region 77 is set to a region where an audience can go back and forth between the virtual projection surface 72 and the virtual projection apparatus 73. For example, a direction from the virtual projection surface 72 toward the virtual projection apparatus 73 is defined as a depth x direction, a lateral direction of the virtual projection surface 72 is defined as a width y direction, and a longitudinal direction of the virtual projection surface 72 is defined as a height z direction. The user of the information processing apparatus 50 designates, for example, a test target region composed of 3 m in the depth x direction from the virtual projection surface 72, the same length as the projection range with respect to the virtual projection surface 72 in the width y direction, and 1.8 m from the floor in the height z direction. In the present example, the test target region 77 is designated as the region of the rectangular parallelepiped surrounded by a one-dot chain line in FIG. 12. The designation by the user may be, for example, a designation by numerical value input with a virtual target as a reference, a designation in which the user designates a periphery of a position at which the device has passed as the test target region while viewing the projection image with the device, or a designation in which the test target region is selected from test target region candidates held in advance by the information processing apparatus 50. The test target region 77 is an example of a “first spatial region” in the present invention.

As shown in FIG. 13, the processor 61 determines a first projection region 74 of the projection light projected from the virtual projection apparatus 73 to the ROI 1 based on the position of the virtual projection surface 72, the position of the virtual projection apparatus 73, and the ROI 1. The processor 61 calculates an overlapping region between the first projection region 74 and the test target region 77 by a logical product operation. The processor 61 determines the calculated overlapping region as the logical product region 78 of the first projection region 74 and the test target region 77. The logical product region 78 in the present example is displayed as a region surrounded by a thick solid line above the test target region 77. The logical product region 78 is a region indicating that overlaps with the first projection region 74 and appears as a shadow within the ROI 1 in a case where the audience passes through the test target region 77.

The processor 61 generates the virtual projection image 91 based on the virtual projection surface 72, the virtual projection apparatus 73, the ROI 1, the first projection region 74, the test target region 77, and the logical product region 78. The virtual projection image 91 is an image in which the virtual projection surface 72, the virtual projection apparatus 73, the ROI 1, the first projection region 74, the test target region 77, and the logical product region 78 are displayed on the space image 71. In addition, the virtual projection image 91 may be generated as an image in which an overlap relationship between the first projection region 74 and the test target region 77 is displayed on the space image 71, for example. The display of the overlap relationship means that at least the logical product region 78 of the first projection region 74 and the test target region 77 is displayed.

The processor 61 may calculate a region in the test target region 77 that does not overlap with the first projection region 74 by a logical difference operation based on the test target region 77 and the first projection region 74 shown in FIG. 13. The processor 61 may determine the calculated non-overlapping region as the logical difference region 79 as shown in FIG. 14. The logical difference region 79 in the present example is displayed as a region obtained by removing the logical product region 78 from the test target region 77. The logical difference region 79 is a region within the test target region 77 that does not overlap with the first projection region 74 and does not cause a shadow in ROI 1, even if the audience passes through it.

The processor 61 generates the virtual projection image 91 based on the virtual projection surface 72, the virtual projection apparatus 73, the ROI 1, and the logical difference region 79. The virtual projection image 91 is an image in which the virtual projection surface 72, the virtual projection apparatus 73, the ROI 1, and the logical difference region 79 are displayed on the space image 71. In addition, the virtual projection image 91 may be generated, for example, as an image in which at least the logical difference region 79 of the first projection region 74 and test target region 77 is displayed on the space image 71. The processor 61 acquires the virtual projection image data representing the virtual projection image 91 and outputs the acquired virtual projection image data to the output destination (for example, the touch panel 51) in the same manner as in the first aspect.

With the information processing apparatus 50 of the second aspect, the region to be secured as the movement line of the audience is set as the test target region 77 in order to prevent the movement lines of the audience from overlapping as little as possible with the first projection region 74. As a result, the overlapping region between the first projection region 74 and the test target region 77 is obtained, and the overlapping region is displayed as the logical product region 78, so that it is possible to easily understand whether or not the movement line of the audience overlaps with the first projection region 74 and the size of the overlapping region. In addition, by obtaining a region in the test target region 77 that does not overlap with the first projection region 74 and displaying the region that does not overlap as the logical difference region 79, it is possible to easily grasp the movement line region of the audience that does not cause a shadow in the ROI 1.

### First Modification Example in Second Aspect

A first modification example of the second aspect of the processing of the information processing apparatus 50 will be described with reference to FIG. 15. FIG. 15 is a diagram in which a virtual projection surface 72, a virtual projection apparatus 73, an ROI 1, and a logical product region 78 are set in the space. In the second aspect, for example, as shown in FIG. 13, a case where the first projection region 74, the test target region 77, and the logical product region 78 are displayed in addition to the virtual projection surface 72, the virtual projection apparatus 73, and the ROI 1 as the image in the space has been described. However, the type and the number of images to be displayed may be switched by selection.

For example, as shown in FIG. 15, the processor 61 may display only the logical product region 78 in addition to the virtual projection surface 72, the virtual projection apparatus 73, and the ROI 1 as the image in the space. The type and the number of images to be displayed can be switched by, for example, a touch operation on the touch panel 51 of the information processing apparatus 50 on which these images are displayed. For example, the virtual projection image 91 of FIG. 13 in which the first projection region 74, the test target region 77, and the logical product region 78 are displayed on the space image 71 and the virtual projection image 91 of FIG. 15 in which the logical product region 78 is displayed on the space image 71 can be switched by performing a touch operation on the touch panel 51.

As in the first modification example, since the type and the number of images to be displayed can be switched by selection, only the region necessary for the user can be displayed, and it is easy to grasp the position and the shape of the region.

### Second Modification Example in Second Aspect

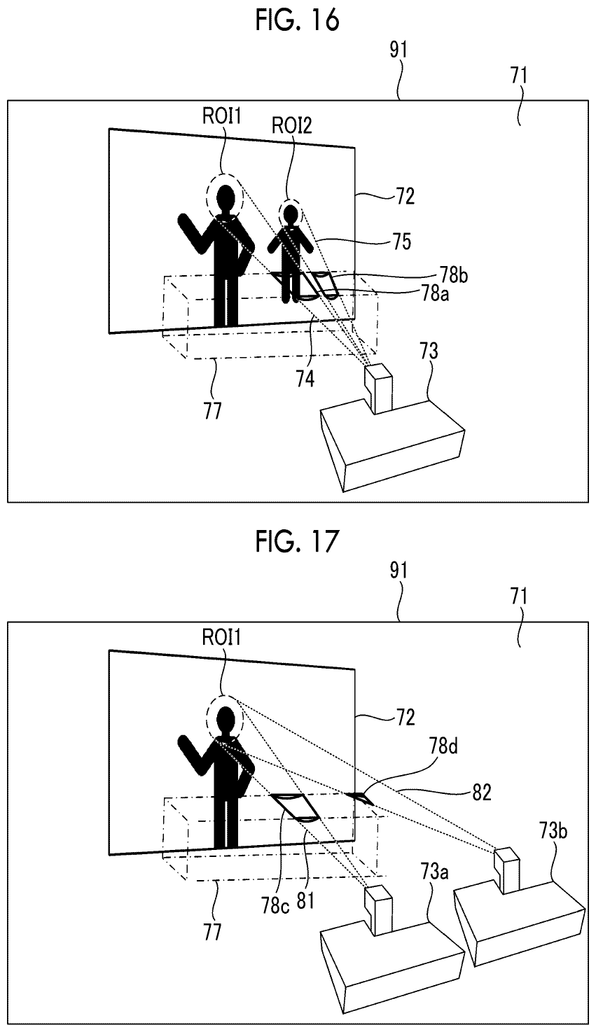

A second modification example of the second aspect of the processing of the information processing apparatus 50 will be described with reference to FIG. 16. In the second aspect, a case where one ROI 1 is designated as an example of designating a part of the region in the virtual projection surface 72 has been described, but the number of regions to be designated may be plural as shown in the second modification example. FIG. 16 is a diagram showing a logical product region in a case in which the ROI 1 and the ROI 2 are designated in the virtual projection surface 72.

As shown in FIG. 16, the processor 61 determines the first projection region 74 of the projection light projected from the virtual projection apparatus 73 to the ROI 1 and determines the second projection region 75 of projection light projected from the virtual projection apparatus 73 to the ROI 2. Then, the processor 61 performs a logical product operation to determine a logical product region 78a as an overlapping region between the first projection region 74 and the test target region 77, and to determine a logical product region 78b as an overlapping region between the second projection region 75 and the test target region 77. The logical product region 78b is a region indicating that overlaps with the second projection region 75 and appears as a shadow within the ROI 2 in a case where the audience passes through the test target region 77.

The processor 61 generates the virtual projection image 91 based on the virtual projection surface 72, the virtual projection apparatus 73, the ROI 1, the first projection region 74, the second projection region 75, the test target region 77, and the logical product regions 78a and 78b. The virtual projection image 91 is an image in which the virtual projection surface 72, the virtual projection apparatus 73, the ROI 1, the ROI 2, the first projection region 74, the second projection region 75, the test target region 77, and the logical product regions 78a and 78b are displayed on the space image 71. In addition, the virtual projection image 91 may be generated, for example, as an image in which at least the logical product region 78a of the first projection region 74 and the test target region 77 and the logical product region 78b of the second projection region 75 and the test target region 77 are displayed on the space image 71.

Even in a case where there are a plurality of pieces of important information (ROI1 and ROI2) in the information content projected onto the virtual projection surface 72 as in the second modification example, the same effect as the second aspect can be obtained.

### Third Modification Example in Second Aspect

A third modification example of the second aspect of the processing of the information processing apparatus 50 will be described. In the second aspect, a case where one test target region 77 is set in the space in which the projection is performed has been described as shown in FIG. 12. However, for example, a plurality of test target regions may be set in the space.

In the second aspect, the test target region 77 having a height z=1.8 m designated as the region of a rectangular parallelepiped is set. However, in the third modification example, in addition to the test target region 77, another test target region having a height z=1.2 m designated as the region of the same rectangular parallelepiped is set. The test target region 77 having a height z of 1.8 m is a test target region assuming an adult with a high height as an audience who travels between the virtual projection surface 72 and the virtual projection apparatus 73. On the other hand, the test target region with a height z=1.2 m set in the third modification example is a test target region assuming a child with a low height as a visiting audience.

Even in a case where two test target regions having different heights are set as in the third modification example, the processor 61 determines the logical product region and the logical difference region between the first projection region 74 and the two test target regions as in FIGS. 13 and 14 of the second aspect. The processor 61 generates, for example, the virtual projection image 91 in which the logical product region or the logical difference region of the first projection region 74 and the two test target regions is displayed. The processor 61 acquires the virtual projection image data representing the generated virtual projection image 91, and outputs the acquired virtual projection image data to the output destination (for example, the touch panel 51 or the like) in the same manner as in the first aspect.

As in the third modification example, by setting the test target region assuming the child with a low height and the test target region assuming the adult with a high height, for example, it is possible to easily set the installation positions of the virtual projection apparatus 73 and the virtual projection surface 72 that can allow the irradiation of the projection light to the adult to some extent but cannot allow the irradiation of the projection light to the child. In addition, it is possible to easily determine the adult viewing position and the child viewing position at which the child can be closer to the virtual projection surface 72 than the adult, as the position at which the projection image can be viewed without blocking the projection light.

### Fourth Modification Example in Second Aspect

A fourth modification example in the second aspect of the processing of the information processing apparatus 50 will be described. In the second aspect, a case where the overlapping region between the first projection region 74 and the test target region 77 is determined as the logical product region 78 has been described as shown in FIG. 13. However, for example, in a case where the projection light passing through the logical product region 78 is blocked, the defect of the projection occurring in the ROI 1 may be displayed in the ROI 1.

The processor 61 determines a region corresponding to the logical product region 78 in which the first projection region 74 and the test target region 77 overlap each other in the ROI 1. The processor 61 displays the region of the ROI 1 corresponding to the logical product region 78 as a region where the projection light is blocked and becomes a shadow, for example, in a case where it is assumed that the audience is in the logical product region 78. The processor 61 displays the region of the ROI 1 corresponding to the logical product region 78, for example, in black or blinks in red.

The processor 61 generates, for example, the virtual projection image 91 in which the region corresponding to the logical product region 78 of the first projection region 74 and the test target region 77 is displayed on the ROI 1. The processor 61 acquires the virtual projection image data representing the generated virtual projection image 91, and outputs the acquired virtual projection image data to the output destination (for example, the touch panel 51 or the like) in the same manner as in the first aspect.

According to the fourth modification example, in a case where an audience who views the projection image moves using the test target region 77 as a moving line or in a case where an object having the same shape as the test target region 77 is disposed in the space, it is possible to visually ascertain, for example, an influence that is generated as a shadow with respect to the projection onto the ROI 1.

### Third Aspect of Processing of Information Processing Apparatus 50

A third aspect of the processing of the information processing apparatus 50 will be described with reference to FIG. 17. FIG. 17 is a diagram showing an example of a virtual projection image 91 in the third aspect. As shown in FIG. 17, in a third aspect of the processing of the information processing apparatus 50, one information content is displayed (stacked) on one virtual projection surface 72 using a plurality of (in the present example, two) first virtual projection apparatuses 73a and second virtual projection apparatuses 73b. As shown in FIG. 17, the processor 61 determines the position of the virtual projection surface 72, the position of the first virtual projection apparatus 73a, and the position of the second virtual projection apparatus 73b in the space in which the projection is performed by the projection apparatus 10. The second virtual projection apparatus 73b is a projection apparatus designated at a position different from the first virtual projection apparatus 73a. The processor 61 determines an ROI 1 indicating a partial region in the virtual projection surface 72. In addition, the processor 61 decides the test target region 77 assumed as the movement line of the audience.

The processor 61 determines a first projection region 81 indicating a range of the projection light from the first virtual projection apparatus 73a to the ROI 1 based on the position of the virtual projection surface 72, the position of the first virtual projection apparatus 73a, and the ROI 1, and determines a third projection region 82 indicating a range of the projection light from the second virtual projection apparatus 73b to the ROI 1 based on the position of the virtual projection surface 72, the position of the second virtual projection apparatus 73b, and the ROI 1. In addition, the processor 61 performs a logical product operation to determine a logical product region 78c as an overlapping region between the first projection region 81 and the test target region 77 and to determine a logical product region 78d as an overlapping region between the third projection region 82 and the test target region 77.

The processor 61 generates the virtual projection image 91 based on the virtual projection surface 72, the first virtual projection apparatus 73a, the second virtual projection apparatus 73b, the ROI 1, the first projection region 81, the third projection region 82, the test target region 77, and the logical product regions 78c and 78d. The virtual projection image 91 is an image in which the virtual projection surface 72, the first virtual projection apparatus 73a, the second virtual projection apparatus 73b, the ROI 1, the ROI 2, the first projection region 81, the third projection region 82, the test target region 77, and the logical product regions 78c and 78d are displayed on the space image 71. In addition, the virtual projection image 91 may be generated, for example, as an image in which at least the logical product region 78c of the first projection region 81 and the test target region 77 and the logical product region 78d of the third projection region 82 and the test target region 77 are displayed on the space image 71.

With the information processing apparatus 50 of the third aspect, even in a case where the information content is projected by a plurality of projection apparatuses by stacking, the same effects as those of the first aspect and the second aspect can be obtained.

### <Fourth Aspect of Processing of Information Processing Apparatus 50>

A fourth aspect of the processing of the information processing apparatus 50 will be described with reference to FIG. 18. FIG. 18 is a diagram showing an example of a situation in which a specific object detected in a space is included in a specific region in the space in which projection is performed by the projection apparatus 10 in the fourth aspect. In the fourth aspect, the information processing apparatus 50 determines a positional relationship between the specific region and the specific object, and notifies that the specific object has entered the specific region in a case where it is determined that the specific object has entered the specific region. The positional relationship is, for example, whether or not a specific object overlaps a specific region.

For example, as shown in FIG. 18, the processor 61 sets the first projection region 74 based on the virtual projection surface 72, the virtual projection apparatus 73, and the ROI 1 designated in the space, and determines whether or not the real person M has entered the first projection region 74. The first projection region 74 is an example of a “specific region” in the present invention. The person M is an example of a “specific object” in the present invention.

Whether or not the person M has entered the first projection region 74 may be detected based on, for example, a captured image of a camera mounted on the information processing apparatus 50, or may be detected based on sensing by a three-dimensional sensor (for example, a LIDAR) mounted on the information processing apparatus 50. For example, in a state in which the first projection region 74 is displayed on the touch panel 51 of the information processing apparatus 50, the person M as the audience role is caused to move the front region of the virtual projection surface 72, and the state is imaged by the camera mounted on the information processing apparatus 50, and it is determined whether or not the person M has entered the first projection region 74 from the captured image.

The processor 61 notifies, for example, the output device (the touch panel 51, the speaker, or the like) of the information processing apparatus 50 of the determination result as to whether or not the person M has entered the first projection region 74. Specifically, the processor 61 displays a portion of the person M that overlaps with the first projection region 74 in the virtual projection image 91 displayed on the touch panel 51 as a high-luminance partial image. In addition, the processor 61 may output a voice from the speaker to indicate that the images are overlapping. In addition, the processor 61 may transmit the determination result to the information terminal carried by the person M. The determination result to be notified may be whether or not the person M who has entered the first projection region 74 has exited the first projection region 74.

With the information processing apparatus 50 of the fourth aspect, in a case where the first projection region 74 is displayed for the purpose of understanding the region in which the shadow is generated in the ROI 1, the person M as the audience role moves on the assumed movement line, and thus it is possible to easily understand whether or not the person M has entered the first projection region 74.

In the above example, the first projection region 74 is exemplified as the “specific region” in the space, but the present invention is not limited thereto. For example, the specific region may be a logical product region 78 shown in FIG. 13 or the like. In addition, in the above example, the real person M is exemplified as the “specific object” detected in the space, but the present invention is not limited to this, and for example, the specific object may be the information processing apparatus 50 or another information processing apparatus. In a case where the first projection region 74 is displayed for the purpose of understanding the region in which the shadow is generated for the ROI 1, the user can easily understand at which position the audience is and in which case the audience enters the first projection region 74 and generates the shadow by moving in the space while holding the information processing apparatus 50.

### Modification Example of Fourth Aspect

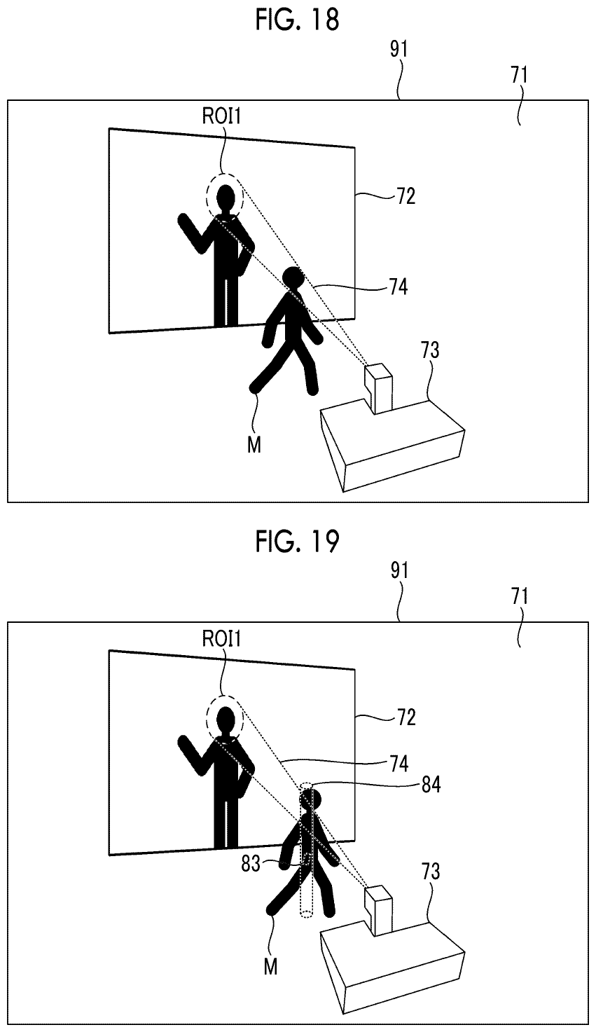

A modification example of the fourth aspect in the processing of the information processing apparatus 50 will be described with reference to FIG. 19. In the fourth aspect, a case in which it is determined whether or not the person M has entered the first projection region 74 has been described, but the specific object to be determined may be an article carried by the person M as shown in the present modification example. FIG. 19 is a diagram showing an example of a case where the determination is performed based on the possession of the person M.

For example, as shown in FIG. 19, the processor 61 sets the first projection region 74 based on the virtual projection surface 72, the virtual projection apparatus 73, and the ROI 1 designated in the space, and determines whether or not the real person M has entered the first projection region 74 based on the position of the smartphone 83 carried by the person M. The smartphone 83 is an example of an “information terminal” in the present invention. The information terminal carried by the person M may be the information processing apparatus 50 or may be another information processing apparatus.

The processor 61 specifies the position of the smartphone 83 carried by the person M by receiving the position information transmitted from the smartphone 83 via wireless communication or the like. The processor 61 decides a virtual person region 84 in which the position of the specified smartphone 83 is extended in the height direction. The processor 61 determines a positional relationship between the virtual person region 84 and the first projection region 74. The virtual person region 84 is set as a region in which the smartphone 83 is present in the horizontal direction and a region having a predetermined length from the floor in the height direction. The region in which the smartphone 83 is present may be, for example, a region of a point that the smartphone 83 is carried by the person M. The predetermined length from the floor is a height of the assumed person M (for example, 180 cm). The processor 61 determines whether or not the virtual person region 84 enters the first projection region 74 from the positional relationship between the determined first projection region 74 and the virtual person region 84.

The processor 61 notifies of the determination result of whether or not the virtual person region 84 has entered the first projection region 74, for example, by using a light emitting part of the smartphone 83 carried by the person M. The light emitting part of the smartphone 83 includes, for example, a display or a rear light of the smartphone 83. Specifically, in a case in which the virtual person region 84 and the first projection region 74 overlap each other, the processor 61 displays an image having high luminance on the display of the smartphone 83. As a result, the light from the virtual projection apparatus 73 is displayed as if the light is reflected by the smartphone 83. In addition, the processor 61 may notify the determination result of whether or not the virtual person region 84 has entered the first projection region 74 via the touch panel 51, the speaker, or the like of the information processing apparatus 50, as in the fourth aspect.

In a case where the person M moves while carrying the smartphone 83 for the purpose of understanding at which position in the space the shadow is cast on the ROI1, for example, it is difficult for the person M having a height of 150 cm to continue to hold the smartphone 83 at a position of 180 cm from the floor surface, assuming the audience having a height of 180 cm. In that case, as in the present modification example, by setting the assumed length of the virtual person region 84 to 180 cm with the position of the floor surface as a reference (0 cm), it is possible to grasp a position that has entered the first projection region 74 without worrying about the portable position (height) of the smartphone 83.

### <Sixth Aspect of Processing of Information Processing Apparatus 50>

A sixth aspect of processing of the information processing apparatus 50 will be described. In the sixth aspect, a new device is further installed in the space in which the projection is performed by the projection apparatus 10, and the effective region of the device is determined. The device is, for example, a sensor such as an infrared sensor. The effective region is a range in which the sensor can collect information.

The processor 61 determines an overlapping region between the effective region of the device and a specific region in the space in which the projection is performed. For example, the processor 61 determines an overlapping region between the effective region of the device and the first projection region 74 and the test target region 77 described above by a logical product operation. The processor 61 generates, for example, a virtual projection image 91 in which the effective region of the device, the first projection region 74, the test target region 77, and the overlapping region of these regions are displayed on the space image 71. The processor 61 acquires the virtual projection image data representing the virtual projection image 91 and outputs the acquired virtual projection image data to the output destination (for example, the touch panel 51) in the same manner as in the first aspect.

Accordingly, it is possible to easily perform a simulation of the operation using a combination of the projection apparatus 10 and the device having the effective region. As an example of such an operation, an operation in which an infrared sensor having a detection range of a vicinity of a front surface of the projection surface of the projection apparatus 10 is installed, a child who shows interest in an image displayed on the projection surface of the projection apparatus 10 and approaches the image is detected by the infrared sensor, and an image in which a flower blooms on the projection surface is projected by the projection apparatus 10 based on the detection of the child by the infrared sensor is considered. In addition, as an example of another operation, an operation in which a position of a person who performs a presentation in front of the projection surface of the projection apparatus 10 is detected by the infrared sensor, and the image position of the operation button projected such that the presenter can operate on the projection surface of the projection apparatus 10 is moved to a position on the projection surface of the projection apparatus 10, which is easy for the presenter to operate, in accordance with the progress of the presentation and displayed is considered. The device having the effective region may be, for example, a device that acts on the effective region of a device that generates wind, water, smell, or the like in a case where a child approaches.

According to the sixth aspect, by displaying the overlapping region of the effective region of the device, the first projection region 74, and the test target region 77, it is possible to easily ascertain whether or not the motion of the audience approaching the effective region of the device affects the projection on the ROI 1. Therefore, the positions of the virtual projection apparatus 73, the virtual projection surface 72, and the device in the space can be appropriately set.

The control method described in the above embodiment can be implemented by executing a control program prepared in advance via a computer. The present control program is recorded on a computer-readable storage medium and executed by reading out the control program from the storage medium. The present control program may be provided in the form of being stored in a non-transitory storage medium such as a flash memory or may be provided through a network such as the Internet. The computer that executes the present control program may be included in the control device, may be included in an electronic apparatus such as a smartphone, a tablet terminal, or a personal computer that can communicate with the control device, or may be included in a server device that can communicate with the control device and the electronic apparatus.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2023-032762) filed on Mar. 3, 2023, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control device
4a, 62: memory
6: projection object
10: projection apparatus
11: projection range
12: optical modulation unit
15: housing
21: light source
22: optical modulation portion
23: projection optical system
24: control circuit
31: second optical system
32, 122: reflective member
33: third optical system
34: lens
50: information processing apparatus
51: touch panel
61: processor
63: communication interface
64: user interface
65: sensor
69: bus
71: space image
72: virtual projection surface
73: virtual projection apparatus
73a: first virtual projection apparatus
73b: second virtual projection apparatus
74, 76, 81: first projection region
75: second projection region
77: test target region
78, 78a to 78d: logical product region
79: logical difference region
82: third projection region
83: smartphone
84: virtual person region
91: virtual projection image
101: body part
102: first member
103: second member
104: projection direction changing mechanism
105: shift mechanism
106: optical unit
121: first optical system
G1: image

What is claimed is:

1. An information processing apparatus comprising:
a processor,
wherein the processor is configured to:
acquire first image data representing a first image in which a space is displayed;
determine a position of a virtual projection surface and a position of a virtual projection apparatus in the space;
determine a first region indicating a part of a region in the virtual projection surface;
determine a first projection region indicating a range of projection light from the virtual projection apparatus to the first region based on the position of the virtual projection surface, the position of the virtual projection apparatus, and the first region; and
output second image data representing a second image in which the first projection region is displayed on the first image to an output destination.

2. The information processing apparatus according to claim 1,
wherein the second image is an image in which the virtual projection surface and the virtual projection apparatus are displayed on the first image.

3. The information processing apparatus according to claim 1,
wherein the processor is configured to:
determine a second region indicating a part of the virtual projection surface and is different from the first region; and
determine a second projection region indicating a range of projection light from the virtual projection apparatus to the second region based on a position of the virtual projection surface, a position of the virtual projection apparatus, and the second region, and
the second image is an image in which the second projection region on the first image is displayed.

4. The information processing apparatus according to claim 1,
wherein the processor is configured to determine the first projection region based on an energy density of the projection light from the virtual projection apparatus to the first region.

5. The information processing apparatus according to claim 1,
wherein the processor is configured to determine a first spatial region in the space, and
the second image is an image representing an overlap relationship between the first projection region and the first spatial region.

6. The information processing apparatus according to claim 1,
wherein the processor is configured to determine a first spatial region in the space, and
the second image is an image representing a region corresponding to an overlapping portion between the first projection region and the first spatial region in the first region.

7. The information processing apparatus according to claim 1,
wherein the processor is configured to:
determine a position of a second virtual projection apparatus different from the virtual projection apparatus in the space; and
determine a third projection region indicating the range of the projection light from the second virtual projection apparatus to the first region based on the position of the virtual projection surface, the position of the second virtual projection apparatus, and the first region, and
the second image is an image in which the third projection region is displayed on the first image.

8. The information processing apparatus according to claim 1,
wherein the processor is configured to output a determination result of a positional relationship between a specific object detected from the space and a specific region in the space.

9. The information processing apparatus according to claim 8,
wherein the specific object is an information terminal, and
the processor is configured to output a determination result of a positional relationship between a region obtained by extending a region of the information terminal in a height direction and the specific region.

10. The information processing apparatus according to claim 8,
wherein the specific object is an information terminal, and
the processor is configured to perform, based on the determination result, control of increasing luminance of a light emitting part of the information terminal.

11. The information processing apparatus according to claim 1,
wherein the processor is configured to:
determine an effective region of a device installed in the space; and
determine an overlapping region between the effective region and a specific region in the space, and
the second image is an image in which the overlapping region is displayed on the first image.

12. The information processing apparatus according to claim 1, further comprising:
an imaging apparatus and a display device,
wherein the first image data is imaging data obtained by imaging the space with the imaging apparatus, and the output destination is the display device.

13. An information processing method executed by a processor included in an information processing apparatus, the information processing method comprising:
acquiring first image data representing a first image in which a space is displayed;
determining a position of a virtual projection surface and a position of a virtual projection apparatus in the space;
determining a first region indicating a part of a region in the virtual projection surface;
determining a first projection region indicating a range of projection light from the virtual projection apparatus to the first region based on the position of the virtual projection surface, the position of the virtual projection apparatus, and the first region; and
outputting second image data representing a second image in which the first projection region is displayed on the first image to an output destination.

14. A non-transitory computer-readable medium storing an information processing program for causing a processor included in an information processing apparatus to execute a process, the process comprising:
acquiring first image data representing a first image in which a space is displayed;
determining a position of a virtual projection surface and a position of a virtual projection apparatus in the space;
determining a first region indicating a part of a region in the virtual projection surface;
determining a first projection region indicating a range of projection light from the virtual projection apparatus to the first region based on the position of the virtual projection surface, the position of the virtual projection apparatus, and the first region; and
outputting second image data representing a second image in which the first projection region is displayed on the first image to an output destination.
